(19) United States
(12) Patent Application Publication
(10) Pub. No.: US 2019/0301612 A1
(43) Pub. Date: Oct. 3, 2019

(54) VENTED LIP SEAL

(71) Applicant: GM Global Technology Operations LLC, Detroit, MI (US)

(72) Inventors: Johnson W. Maina, Waterford, MI (US); Edward J. Billings, Ann Arbor, MI (US)

(21) Appl. No.: 15/941,113

(22) Filed: Mar. 30, 2018

(51) Int. Cl. F16J 15/3204; F16H 61/30

(52) U.S. Cl. CPC F16J 15/3204; F16J 15/3268; F16H 61/30

(57) ABSTRACT

A system for venting air from an automatic transmission clutch piston cavity includes a piston positioned in a piston cavity. The piston is slidably disposed to engage a clutch. A lip seal is seated in a seal groove of the piston. The lip seal includes: a body of a resilient material; multiple slots preformed about an outer perimeter of the body, each of the slots opening outwardly from an outer perimeter surface of the lip seal; and an angular spacing separating successive ones of the slots. Air within the piston cavity is vented through the multiple slots by application of a pressurized fluid against the lip seal.

### INTRODUCTION

The present disclosure relates to seals used in automobile vehicle transmissions.

Automatic transmissions for automobile vehicles, including trucks and vans commonly use D-ring seals in locations such as transmission fluid entrances into cavities having pistons which control clutches and brakes. The D-ring seals maintain pressure of the transmission fluid for actuation of the clutch or brake, and to minimize transmission fluid leakage. The spaces such as between a transmission fluid inlet cavity and a piston for activation of a clutch rapidly fill with transmission fluid as the hydraulic pump is energized. When the engine and the hydraulic pump are shut off the transmission fluid gravity drains from the inlet cavity back to a transmission sump. This drainage permits air to enter the cavity, which remains until the hydraulic pump is reenergized to re-pressurize the system. During subsequent start of the engine and hydraulic pump, the air entrained with the transmission fluid if not bled off compresses and causes both a time delay and a noticeable “shift flair” as the clutch is initially engaged.

To avoid clutch actuation time delay and shift flair, known solutions to bleed off the air include incorporation of bleed ports which are continuously open to the pressurized fluid during transmission operation. A continuously open bleed port is not acceptable in transmission designs where the bleed port opens to cavities which may permit pressurized transmission fluid to effect other clutches or brakes.

Thus, while current automatic transmission seal designs achieve their intended purpose, there is a need for a new and improved system and method for bleeding entrapped air from transmission clutch or brake cavities.

### SUMMARY

According to several aspects, a lip seal includes a body of a resilient material defining a substantially circular shape. Multiple slots are preformed about an outer perimeter of the body. Each of the slots define a substantially rectangular shape opening outwardly from an outer perimeter surface of the lip seal. An angular spacing separates successive ones of the slots.

In another aspect of the present disclosure, the multiple slots define six slots each equidistantly positioned from a successive one of the slots.

In another aspect of the present disclosure, the angular spacing defines approximately 60 degrees provided between successive ones of the slots.

In another aspect of the present disclosure, a recessed ring cavity is located between the outer perimeter surface and an inner perimeter surface of the body. The recessed ring cavity enhances elastic deflection of the lip seal when a pressurized fluid is applied to the recessed ring cavity.

In another aspect of the present disclosure, the recessed ring cavity extends circumferentially about the lip seal body.

In another aspect of the present disclosure, the recessed ring cavity opens outwardly from a first face of the lip seal body, the first face oriented substantially perpendicular to the inner perimeter surface.

In another aspect of the present disclosure, the outer perimeter surface is angularly oriented with respect to the first face and tapers toward an intersection with a second face.

In another aspect of the present disclosure, the first face is oriented substantially parallel to the second face.

In another aspect of the present disclosure, the angular spacing is equal between any two successive one of the slots.

In another aspect of the present disclosure, the angular spacing is random between any two successive one of the slots.

According to several aspects, a system for venting air from an automatic transmission clutch piston cavity includes a piston positioned in a piston cavity. The piston is slidably disposed to engage a clutch. A lip seal is seated in a seal groove of the piston. The lip seal includes: a body of a resilient material; multiple slots preformed about an outer perimeter of the body, each of the slots opening outwardly from an outer perimeter surface of the lip seal; and an angular spacing separating successive ones of the slots.

In another aspect of the present disclosure, air within the piston cavity is vented through the multiple slots by application of a pressurized fluid against the lip seal.

In another aspect of the present disclosure, continued application of the pressurized fluid elastically deforms the lip seal to seat against a housing collapsing the multiple slots.

In another aspect of the present disclosure, the body defines a substantially circular shape and each of the multiple slots define a substantially rectangular shape.

In another aspect of the present disclosure, a housing slidably receives the piston. The housing is connected to and rotates an output shaft.

In another aspect of the present disclosure, the lip seal includes an outer perimeter surface of the outer perimeter of the body, the outer perimeter surface in direct contact with the housing except at each of the multiple slots.

In another aspect of the present disclosure, the lip seal includes a recessed ring cavity extending circumferentially about the lip seal body and located between the outer perimeter surface and an inner perimeter surface of the body. The recessed ring cavity enhances elastic deflection of the lip seal when a pressurized fluid is applied to the recessed ring cavity.

According to several aspects, a system for venting air from an automatic transmission clutch piston cavity includes a housing connected to and rotating an output shaft. A piston is positioned in a piston cavity of the housing. The piston is slidably displaced to engage a clutch. A lip seal is seated in a seal groove of the piston. The lip seal includes: a body of a resilient material defining a substantially circular shape; an outer perimeter of the body having an outer perimeter surface in contact with the housing; and multiple slots preformed about the outer perimeter of the body, each of the slots defining a substantially rectangular shaped opening directed outwardly from the outer perimeter surface of the lip seal. Air within the piston cavity is vented through the multiple slots between the housing and the outer perimeter surface by introduction of a pressurized fluid into the piston cavity acting against the lip seal.

In another aspect of the present disclosure, continued application of the pressurized fluid elastically deforms the lip seal to seat against the housing thereby collapsing the multiple slots.

In another aspect of the present disclosure, a discharge passage is positioned on an opposite side of the piston from the piston cavity which receives and discharges the air that bleeds past the piston.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational cross sectional view of a transmission having a vented lip seal according to an exemplary embodiment;

FIG. 2 is a front elevational view of the lip seal of FIG. 1;

FIG. 3 is a front elevational view of area 3 of FIG. 2;

FIG. 4 is a cross sectional end elevational view taken at section 4 of FIG. 3;

FIG. 5 is an enlarged front elevational view similar to FIG. 3;

FIG. 6 is a cross sectional side elevational view taken at section 6 of FIG. 1; and

FIG. 7 is a cross sectional side elevational view modified from FIG. 6 to show elastic deformation of the lip seal.

### DETAILED DESCRIPTION

The following description is merely exemplary in nature and is not intended to limit the present disclosure, application, or uses.

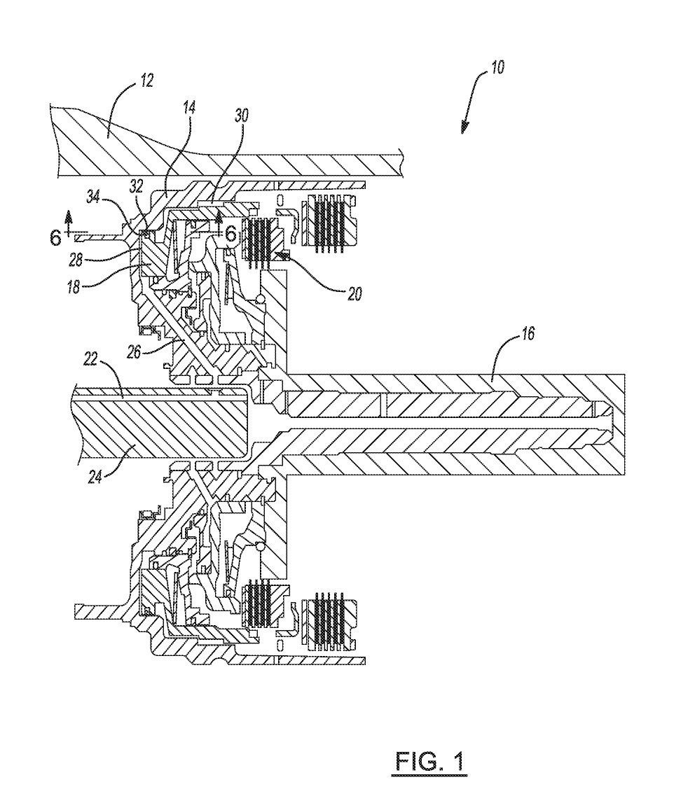

Referring to FIG. 1, an automobile vehicle automatic transmission 10 includes a transmission housing 12 within which an inner housing 14 axially rotates. The inner housing 14 is connected to an output shaft 16 to axially rotate the output shaft 16. Multiple pistons positioned within the inner housing 14 are provided to engage or disengage multiple clutch members. These include at least one piston 18 which is hydraulically actuated to engage or disengage a multiple plate friction clutch 20. Pressurized transmission fluid is provided by operation of a hydraulic pump (not shown) to actuate individual ones of the multiple clutches including the friction clutch 20 via a fluid passage 22 of an input shaft 24. Pressurized transmission fluid is directly provided to displace the piston 18 via dedicated control valves (not shown) through a dedicated passage 26, which leads to a piston cavity 28 of the inner housing 14.

Transmission fluid in the piston cavity 28 and the dedicated passage 26 normally gravity drains down to a transmission sump (not shown) when the hydraulic pump is shut off. This permits air to enter the piston cavity 28 via the dedicated passage 26. A discharge passage 30 is also provided on an opposite side of the piston 18 from the piston cavity 28 which receives and discharges any air or transmission fluid leakage past the piston 18. According to several aspects, a lip seal 32 is positioned in a seal groove 34 provided in the piston 18. A first function of the lip seal 32 is to slidably seat against an inner face of the inner housing 14 as the piston 18 slidingly displaces under normal operating conditions when pressurized transmission fluid acts against the piston 18. Under normal operating conditions with full transmission fluid pressure applied, the lip seal 32 elastically deflects and by physically contacting the inner face of the inner housing 14 prevents leakage of pressurized transmission fluid in the piston cavity 28 from bypassing the piston 18 and entering the discharge passage 30.

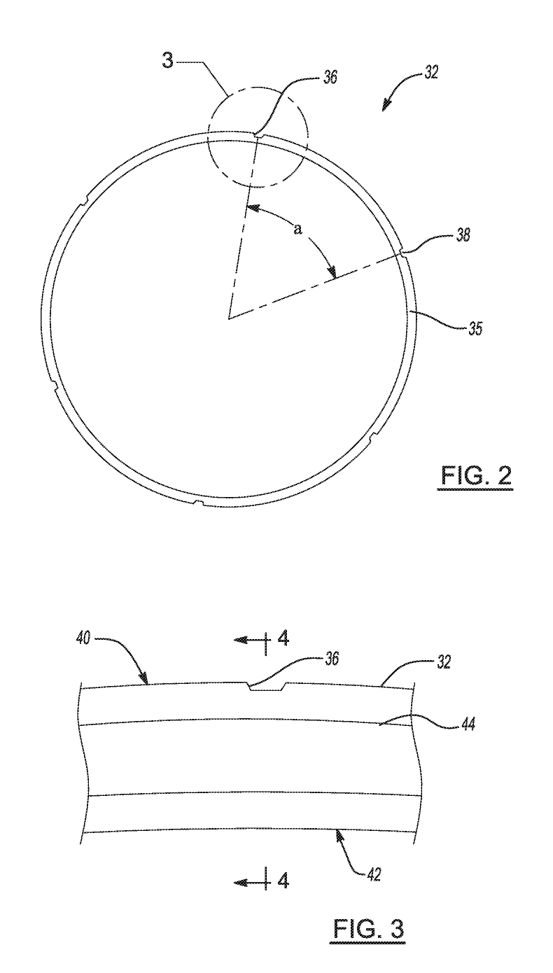

After the hydraulic pump is shut off, transmission fluid drains out of and air accumulates into the piston cavity 28. This air volume upon subsequent operation of the hydraulic pump could impact the timing of the sliding motion of the piston 18 and therefore negatively impact actuation of the friction clutch 20. A second function of the lip seal 32 is therefore provided to vent air from the piston cavity 28 into the discharge passage 30 when the hydraulic pump is started, but before the lip seal 32 fully deflects under pressurized loading of the transmission fluid. The second function will be described in greater detail in reference to FIGS. 2 through 7 below.

Referring to FIG. 2 and again to FIG. 1, the lip seal 32 includes a body 35 defining a substantially circular shape, and is formed of a resilient material adapted for contact with high temperature transmission fluid. To allow initial venting of air past the lip seal 32, multiple slots are preformed about an outer perimeter of the body 35 of the lip seal 32, for example during a molding process. According to several aspects six slots are provided, each equidistantly positioned from a successive one of the slots. An angular spacing of approximately 60 degrees between slots may therefore be provided, which can be varied depending on a total quantity of the slots. In the example shown in FIG. 2, a first slot 36 is spaced at an angular arc alpha (α) of approximately 60 degrees from a second slot 38. Additional successive slots are equally spaced at the angular arc a about a perimeter of the lip seal 32. The quantity of slots can vary and can be greater or less than six, therefore the angular spacing between successive slots can vary accordingly.

According to several aspects, if the transmission design warrants, the slots can be arranged in a less orderly, non-equally spaced pattern, for example having all of the slots positioned within a 180 to 270 degree range along the perimeter of the lip seal. The non-equally spaced configuration can be used for example if a lower portion of the lip seal is positioned within a sump where transmission fluid but no air is present during any operating condition, therefore the slots can all be positioned about the lip seal in locations above the continuous level of transmission fluid where air may be present. The angular spacing between any two of the slots can also be random.

Referring to FIG. 3 and again to FIGS. 1 and 2, each of the slots such as the first slot 36 defines a substantially rectangular shape opening outwardly from an outer perimeter surface 40 of the lip seal 32. An inner perimeter surface 42 is positioned within and contacts an end wall of the seal groove 34 provided in the piston 18 in the installed position of the lip seal 32 shown in FIG. 1. The lip seal 32 also includes a recessed ring cavity 44 located between the outer perimeter surface 40 and the inner perimeter surface 42 which extends circumferentially about the lip seal 32. The recessed ring cavity 44 provides a local cross sectional reduction of the material of the lip seal 32, thereby allowing the lip seal 32 to locally deflect, which permits and enhances overall elastic deflection of the lip seal 32 when pressurized transmission fluid is applied or removed.

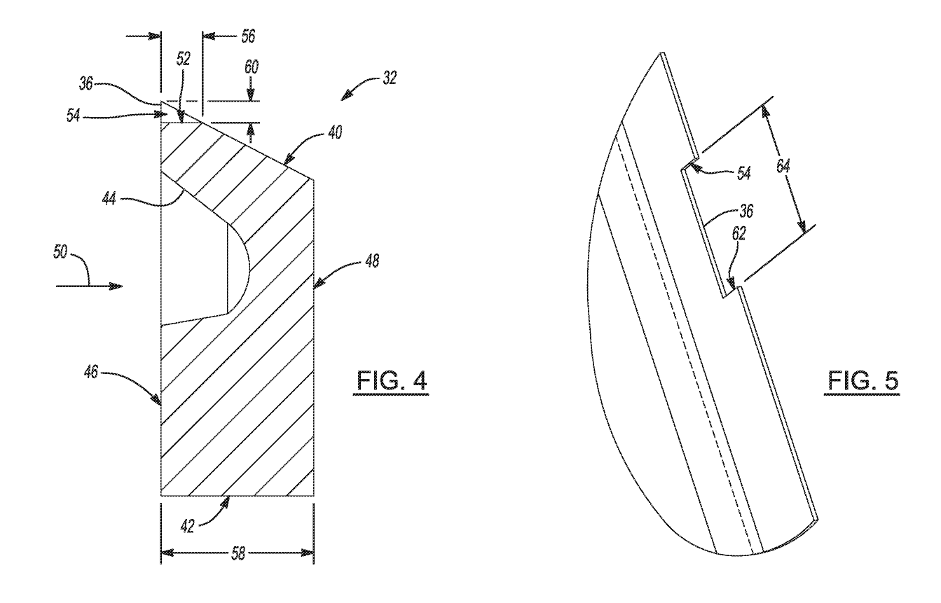

Referring to FIG. 4 and again to FIGS. 1 through 3, the recessed ring cavity 44 opens outwardly from a first face 46, which according to several aspects is oriented substantially perpendicular to the inner perimeter surface 42. In contrast, the outer perimeter surface 40 is angularly oriented with respect to the first face 46 and tapers toward an intersection with a second face 48. According to several aspects the first face 46 is oriented substantially parallel to the second face 48, therefore the outer perimeter surface 40 is not oriented parallel to the inner perimeter surface 42. When the lip seal 32 is positioned in the seal groove 34 provided in the piston 18 and pressurized with transmission fluid in a pressure application direction 50, the outer perimeter surface 40 elastically deflects upwardly and toward the right as viewed in FIG. 4 until the outer perimeter surface 40 contacts and seals against the inner face of the inner housing 14.

To initially allow venting of air present in the piston cavity 28 to flow into the discharge passage 30, as transmission fluid pressure builds against the first face 46, but before the outer perimeter surface 40 fully deflects to contact and seal against the inner face of the inner housing 14 thereby closing off the multiple slots, air venting is provided through the multiple slots, including through the first slot 36. Each of the slots is similar to the first slot 36, therefore the following discussion of the first slot 36 applies equally to the remaining slots. The first slot 36 is formed in the tapering outer perimeter surface 40 and defines a slot bottom face 52 positioned between opposed slot walls 54, 62 (only slot wall 54 is visible in this view, with the slot wall 62 shown in FIG. 5). According to several aspects the slot bottom face 52 is oriented substantially parallel to the inner perimeter surface 42. A length 56 of the slot bottom face 52 can range between approximately 5% to approximately 25% of a total thickness 58 of the lip seal 32, and a depth 60 of the first slot 36 can also vary to change the volumetric air flow through the slots for different lip seal sizes.

Referring to FIG. 5 and again to FIG. 4, similar to the length 56 of the slot bottom face 52 and the depth 60, a width 64 of each slot such as the first slot 36 between the opposed slot walls 54, 62 can also vary to change the volumetric air flow through the slots for different lip seal sizes. The rectangular entrance shape of the slots is not determinative, but is selected to minimize mold tooling cost.

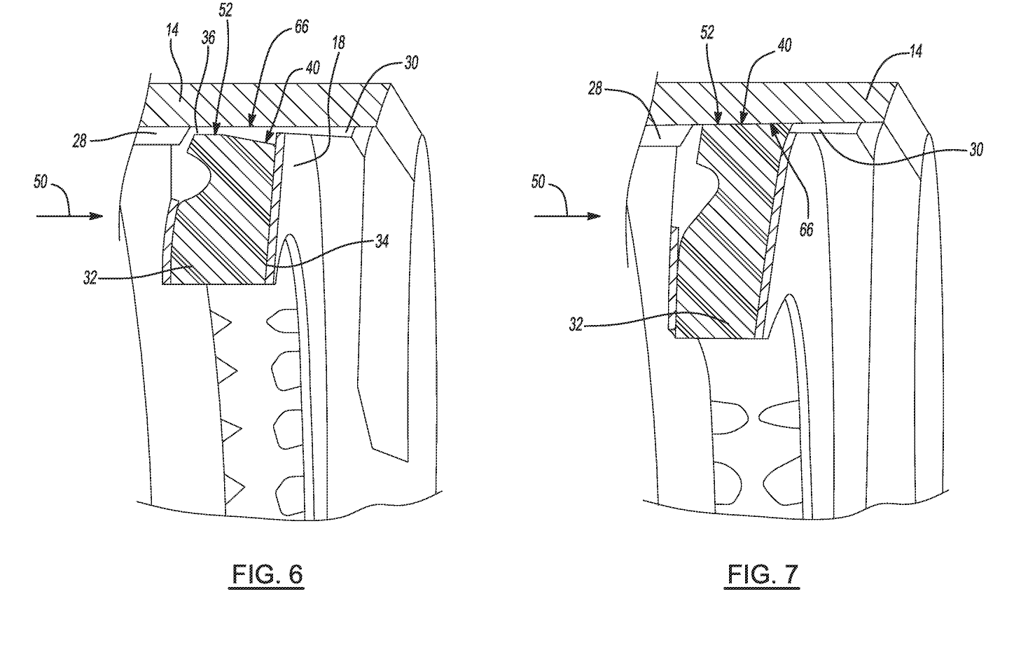

Referring to FIG. 6 and again to FIGS. 1 through 5, the lip seal 32 is shown in a relaxed state when the hydraulic pump is off and no transmission fluid pressure is acting against the lip seal 32. As previously noted, when the hydraulic pump is off transmission fluid drains from the piston cavity 28, allowing air to enter and accumulate in the piston cavity 28. In this state, the slot bottom face 52 of the first slot 36 is spaced away from an inner face 66 of the inner housing 14 providing a flow path for air to bleed from the piston cavity 28 to the discharge passage 30. When the hydraulic pump is next initiated, transmission fluid flows into the piston cavity 28 and transmission fluid pressure begins to build in the pressure application direction 50. Before substantial deformation of the lip seal 32 occurs, air in the piston cavity is forced to bleed outward through the first slot 36 (as well as through the other slots) into the discharge passage 30.

Referring to FIG. 7 and again to FIG. 6, with the lip seal 32 retained in the seal groove 34 provided in the piston 18, pressure applied by the transmission fluid acting in the pressure application direction 50 elastically deflects the lip seal 32. After the initial period of air bleed described in reference to FIG. 6, continued elastic deformation continues until the outer perimeter surface 40 elastically deflects upwardly as viewed in FIG. 7 and the outer perimeter surface 40 directly contacts and seals against the inner face 66 of the inner housing 14. This contact also collapses the first slot 36 as the slot bottom face 52 also contacts the inner face 66 of the inner housing 14. The bleed flow path between the piston cavity 28 and the discharge passage 30 is thereby blocked and remains blocked to prevent discharge of transmission fluid into the discharge passage 30 during normal operation of the transmission.

A vented lip seal of the present disclosure offers several advantages. These include the provision of multiple slots in a resilient body lip seal. When the lip seal is seated in a seal groove of a piston that displaces to actuate a friction clutch of an automatic transmission, the slots provide a path for air in a piston cavity to bleed past the piston to a discharge passage. The resilient material of the lip seal further allows increasing fluid pressure acting on the lip seal to elastically deform the lip seal, collapsing the slots and thereafter preventing flow of fluid or air past the piston.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A lip seal, comprising:
a body of a resilient material defining a substantially circular shape;
multiple slots preformed about an outer perimeter of the body, each of the slots defining a substantially rectangular shape opening outwardly from an outer perimeter surface of the lip seal; and
an angular spacing separating successive ones of the slots.

2. The lip seal of claim 1, wherein the multiple slots define six slots each equidistantly positioned from a successive one of the slots.

3. The lip seal of claim 1, wherein the angular spacing defines approximately 60 degrees provided between successive ones of the slots.

4. The lip seal of claim 1, further including a recessed ring cavity located between the outer perimeter surface and an inner perimeter surface of the body, the recessed ring cavity enhancing elastic deflection of the lip seal when a pressurized fluid is applied to the recessed ring cavity.

5. The lip seal of claim 4, wherein the recessed ring cavity extends circumferentially about the lip seal body.

6. The lip seal of claim 4, wherein the recessed ring cavity opens outwardly from a first face of the lip seal body, the first face oriented substantially perpendicular to the inner perimeter surface.

7. The lip seal of claim 6, wherein the outer perimeter surface is angularly oriented with respect to the first face and tapers toward an intersection with a second face.

8. The lip seal of claim 7, wherein the first face is oriented substantially parallel to the second face.

9. The lip seal of claim 1, wherein the angular spacing is equal between any two successive one of the slots.

10. The lip seal of claim 1, wherein the angular spacing is random between any two successive one of the slots.

11. A system for venting air from an automatic transmission clutch piston cavity, comprising:
a piston positioned in a piston cavity, the piston slidably disposed to engage a clutch; and
a lip seal seated in a seal groove of the piston, the lip seal including:
a body of a resilient material;
multiple slots preformed about an outer perimeter of the body, each of the slots opening outwardly from an outer perimeter surface of the lip seal; and
an angular spacing separating successive ones of the slots.

12. The system for venting air from an automatic transmission clutch piston cavity of claim 11, wherein air within the piston cavity is vented through the multiple slots by application of a pressurized fluid against the lip seal.

13. The system for venting air from an automatic transmission clutch piston cavity of claim 12, wherein continued application of the pressurized fluid elastically deforms the lip seal to seat against a housing collapsing the multiple slots.

14. The system for venting air from an automatic transmission clutch piston cavity of claim 11, wherein the body defines a substantially circular shape and each of the multiple slots define a substantially rectangular shape.

15. The system for venting air from an automatic transmission clutch piston cavity of claim 11, further including a housing slidably receiving the piston, the housing connected to and rotating an output shaft.

16. The system for venting air from an automatic transmission clutch piston cavity of claim 15, wherein the lip seal includes an outer perimeter surface of the outer perimeter of the body, the outer perimeter surface in direct contact with the housing except at each of the multiple slots.

17. The system for venting air from an automatic transmission clutch piston cavity of claim 11, wherein the lip seal includes a recessed ring cavity extending circumferentially about the lip seal body and located between the outer perimeter surface and an inner perimeter surface of the body, the recessed ring cavity enhancing elastic deflection of the lip seal when a pressurized fluid is applied to the recessed ring cavity.

18. A system for venting air from an automatic transmission clutch piston cavity, comprising:
a housing connected to and rotating an output shaft;
a piston positioned in a piston cavity of the housing, the piston slidably displaced to engage a clutch; and
a lip seal seated in a seal groove of the piston, the lip seal including:
a body of a resilient material defining a substantially circular shape;
an outer perimeter of the body having an outer perimeter surface in contact with the housing; and
multiple slots preformed about the outer perimeter of the body, each of the slots defining a substantially rectangular shaped opening directed outwardly from the outer perimeter surface of the lip seal;
wherein air within the piston cavity is vented through the multiple slots between the housing and the outer perimeter surface by introduction of a pressurized fluid into the piston cavity acting against the lip seal.

19. The system for venting air from an automatic transmission clutch piston cavity of claim 18, wherein continued application of the pressurized fluid elastically deforms the lip seal to seat against the housing thereby collapsing the multiple slots.

20. The system for venting air from an automatic transmission clutch piston cavity of claim 18, further including a discharge passage positioned on an opposite side of the piston from the piston cavity which receives and discharges the air that bleeds past the piston.
